(19) United States
(12) Patent Application Publication
(10) Pub. No.: US 2014/0040537 A1
(43) Pub. Date: Feb. 6, 2014

(54) STORAGE MEDIUM USING NONVOLATILE SEMICONDUCTOR STORAGE DEVICE, AND DATA TERMINAL INCLUDING THE SAME

(71) Applicant: GENUSION INC., Hyogo (JP)

(72) Inventors: Moriyoshi NAKASHIMA, Hyogo (JP); Junichi IKEGAMI, Hyogo (JP)

(73) Assignee: GENUSION INC., Hyogo (JP)

(21) Appl. No.: 13/955,493

(22) Filed: Jul. 31, 2013

(30) Foreign Application Priority Data
Aug. 1, 2012 (JP) 2012-171214
Jul. 31, 2013 (JP) 2013-158921

(51) Int. Cl. G06F 12/02

(52) U.S. Cl. CPC G06F 12/0246
USPC 711/103

(57) ABSTRACT

A storage medium using a nonvolatile semiconductor storage device for preventing an inadvertent file leak as much as possible is provided. A storage medium using a nonvolatile semiconductor storage device includes a control unit for writing data to memory cells which store data corresponding to files stored on the storage medium, such that all the memory cells are put into the same electronic state, or for erasing data from the memory cells, after a lapse of a set time period.

### CROSS REFERENCE TO RELATED APPLICATION

This application is based upon and claims priority to Japanese Patent Applications No. 2012-171214 filed on Aug. 1, 2012, and No. 2013-158921 filed on Jul. 31, 2013; the entire contents of which are incorporated herein by reference.

1. Field of the Invention

The present invention relates to a storage medium using a nonvolatile semiconductor storage device, a data terminal including the same, and a file erasing method usable for the same. Specifically, the present invention relates to a storage medium and a data terminal for improving security so that a file can be erased with certainty.

2. Description of the Related Art

Conventionally, files generated by a personal computer or the like are mainly stored on a USB memory or the like using a NAND flash memory. However, a USB memory or the like may be possibly lost. In the case where a file stored thereon includes sensitive information such as private information or the like or business secrets which need to be kept confidential strictly, a serious business loss may be incurred if such a USB memory is lost. In order to avoid such a loss, files are manually erased based on certain criteria, or software including an algorithm for erasing files at a certain timing is implemented on a personal computer.

For storing a file on a USB memory or the like using a NAND flash memory, a storage area is divided into a data area and a file management area. For erasing a file, the file management area is flagged so that it is merely considered that the corresponding file is “erased”. This merely causes a situation where when the medium such as the USB memory or the like is formatted, the management area is erased and a start address of the file in the data area cannot be specified, which makes it difficult to read the file. In order to erase the file so as not to be unrecoverable, fixed data such as FF or 00 needs to be written in the entire data area. Software for this purpose is known.

In such circumstances, a storage medium which allows data to be erased therefrom with certainty on a file-by-file basis and a file erasing method usable for such a storage medium are desired.

The present applicant has proposed a B4 flash memory, which is a large capacity nonvolatile semiconductor storage device capable of replacing a NAND flash memory. The B4 flash memory provides a significantly larger number of cycles of write and erase, allows data to be written or erased in a shorter time, and requires only a small total power consumption for a write operation and an erase operation. A method for improving security which is preferable for the B4 flash memory and makes a maximum use of the characteristics thereof has been studied.

Patent Document 1: Japanese Laid-Open Patent Publication No. 2006-156925

The present invention has an object of providing a file erasing method for erasing a file from a storage medium using a nonvolatile semiconductor storage device, by which data is erased with certainty on a file-by-file basis under the condition that, for example, a certain time period has lapsed, and thus an inadvertent file leak is prevented as much as possible; and a storage medium on which the file erasing method can be used.

### SUMMARY OF THE INVENTION

Provided in an embodiment of the present invention is a storage medium using a nonvolatile semiconductor storage device, comprising a control unit for writing data to memory cells which store data corresponding to files stored on the storage medium, such that all the memory cells are put into the same electronic state, or for erasing data from the memory cells, after a lapse of a predetermined time period. (Hereinafter, the write and erase will be collectively referred to as “erase or the like”).

The control unit may include a clock showing a lapse of the set time period. The storage medium may further include a battery or a capacitor. When the storage medium is connected to another device, the battery may be charged by the another device, whereas when the storage medium is disconnected from the another device, the battery may supply power to the nonvolatile semiconductor storage device and the control unit.

The nonvolatile semiconductor storage device may hold set time period-related data corresponding to the set time period. When the storage medium is connected to another device, the control unit may read the set time period-related data and acquire time from the another device; and when determining that the set time has lapsed, the control unit may perform erase or the like.

The set time period may be created based on time acquired by the another device via the Internet, and the time acquired by the control unit from the another device is desirably acquired via the Internet. The control unit may be structured to read the stored file only after writing or erasing the data.

The nonvolatile semiconductor device may hold a unique identification code; the control unit may hold an authorization code corresponding to the identification code; and only when the identification code and the authorization code correspond to each other, the control unit may be allowed to access the nonvolatile semiconductor device.

A data terminal in an embodiment according to the present invention includes the above-described the storage medium. In this data terminal, the storage medium stores user data.

According to the present invention, a storage medium using a nonvolatile semiconductor storage device, which prevents an inadvertent file leak as much as possible, can be provided.

### BRIEF EXPLANATION OF THE DRAWINGS

FIG. 1 is a cross-sectional view showing a structure of a memory cell for performing a B4 write operation.

FIG. 2 is a circuit diagram of a memory cell array including memory cells for performing a B4 write operation.

FIG. 3 is a block diagram of a B4 memory die.

FIG. 4 is a schematic view of a package including a plurality of B4 memory dies.

FIG. 5 is a block diagram showing a circuit configuration of a USB memory according to the present invention.

FIG. 6 is a flowchart showing an operation according to the present invention.

FIG. 7 is a block diagram showing a power supply circuit of a USB memory according to the present invention.

FIG. 8 shows the relationship among banks, blocks and pages in one die.

FIG. 9 shows a flow of file erase in an embodiment according to the present invention.

FIG. 10 is a flowchart showing a flow of file erase in an embodiment according to the present invention.

FIG. 11 is a block diagram showing a circuit configuration of a data terminal in an embodiment according to the present invention.

FIG. 12 is a block diagram showing a circuit configuration of another data terminal in an embodiment according to the present invention.

### DESCRIPTION OF THE PREFERRED EMBODIMENTS

Hereinafter, embodiments for carrying out the present invention will be described. The present invention is not limited to the following embodiments. The embodiments described below may be modified in various manners to carry out the present invention.

Example of B4 flash memory

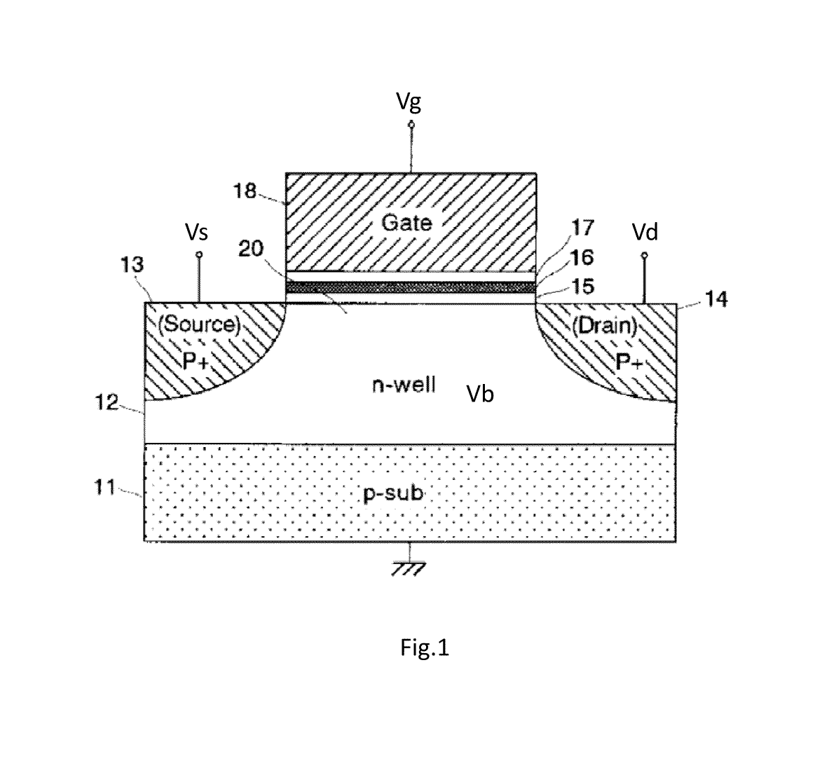

FIG. 1 is a cross-sectional view showing a structure of a memory cell of a B4 flash memory usable in the present invention. Herein, the “B4 flash memory” refers to a flash memory including a memory cell which includes a p-type MOS transistor that is formed in an n-well and has an accumulation area such as, for example, a nitride film or a floating gate. In the B4 flash memory, the voltage relationship at the time of write is Vg, Vb>Vs>Vd (where Vg is the gate voltage, Vb is the substrate bias voltage, Vs is the source voltage, and Vd is the drain voltage), and the value of Vg−Vd is equal to or higher than the voltage at which an inter-band tunnel current is generated.

As shown in FIG. 1, the memory cell according to the present invention is a p-type MOS transistor formed in an n-well 12, which is formed on a p-type semiconductor substrate (p-sub) 11. The p-type MOS transistor includes a source 13 and a drain 14, which are p+-type diffused areas separated from each other, and also includes a channel region 20 located between the source 13 and the drain 14. On the channel region 20, an ONO film including an oxide film 15, a nitride film 16 and an oxide film 17 is formed. On the ONO film, a gate 18 formed of polycrystalline silicon doped with impurities is provided. A floating gate may be used instead of the nitride film 16. The nitride film 16 or the floating gate forms a charge accumulation layer. Vg is the voltage to be applied to the gate 18, Vb is the substrate bias voltage, Vs is the voltage to be applied to the source 13, and Vd is the voltage to be applied to the drain 14.

Data is read from the memory cell shown in FIG. 1 as follows. The voltage Vd of about 1 V, the voltage Vb of 1.8 V (equal to the power supply voltage Vcc), the voltage Vs of 1.8 V, and the voltage Vg of, for example, −2.2 V (corresponding to the voltage among a plurality of states in the case of a multi-level cell) are applied. When the threshold value of the memory cell is lower than −2.2 V, a current flows; whereas when the threshold value of the memory cell is higher than −2.2 V, a current does not easily flow. The difference between the threshold value and −2.2 V is detected to make a determination on written data.

Data is written to the memory cell shown in FIG. 1 as follows. The voltage Vd of 0 V, the voltage Vb of 4.5 V, the voltage Vs of 1.8 V, and the voltage Vg of, for example, 7 V are applied. Then, the written data is verified by a verify operation (operation of reading data at a slightly strict condition of, for example, Vg=−3.0 V). The above-mentioned write voltages are applied in repetition until a target threshold value is obtained. Among the write voltages, the voltage Vg is gradually raised each time the write cycle is repeated, and is raised to 12 V at the maximum.

Data is erased from the memory cell shown in FIG. 1 as follows. The voltage Vd is opened, and the voltage Vg is made −10 V and the voltage Vs is made equal to the voltage Vb. The voltage Vg is gradually raised each time the erase cycle is repeated, and is raised to 12 V at the maximum. The erase operation is performed on a block-by-block basis.

In the B4 flash memory described above, the length of the channel region between the source and the drain can be shortened to raise the integration degree, both of the write operation and the erase operation can be performed at a high rate, and the write cycle and the erase cycle are performed by a significantly larger number than in a NAND flash memory. Even after a rewrite operation is performed many times, data can be held stably for a long period of time even at a high temperature.

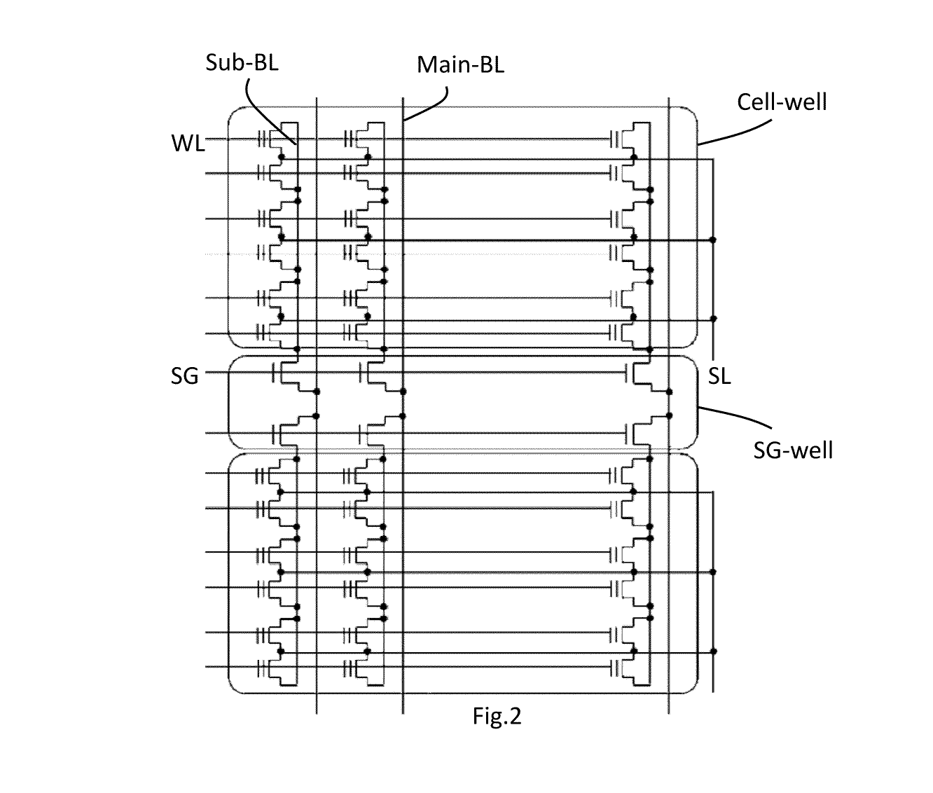

FIG. 2 is a circuit diagram of a memory cell array of the B4 flash memory. In a column direction, n-type cell-wells and p-type select gate wells (SG-wells) are located alternately. Each cell-well includes a plurality of p-type memory cells located in a matrix. The plurality of memory cells included in each cell-well form a block, which is a unit for data erase. Each cell-well is supplied with the bias voltage Vb. The sources of all the memory cells in each block are commonly connected to a source line SL. The voltage Vs is supplied via the source line SL. In each block, the drains of the memory cells belonging to the same column are commonly connected to a sub bit line (Sub-BL). The voltage Vd is supplied via the sub bit line. Lines extending in a row direction are word lines WL. Gate electrodes of the memory cells belonging to the same row are connected to the same word line WL. The memory cells located in each row form a page. The voltage Vg is supplied via each word line. Each select gate well includes a plurality of n-type select gate transistors. Select gate transistors are provided for each column, and each select gate transistor selectively connects a sub bit line and a main bit line corresponding to each other. Gate electrodes of the select gate transistors in the same row are connected to the same select gate line SG.

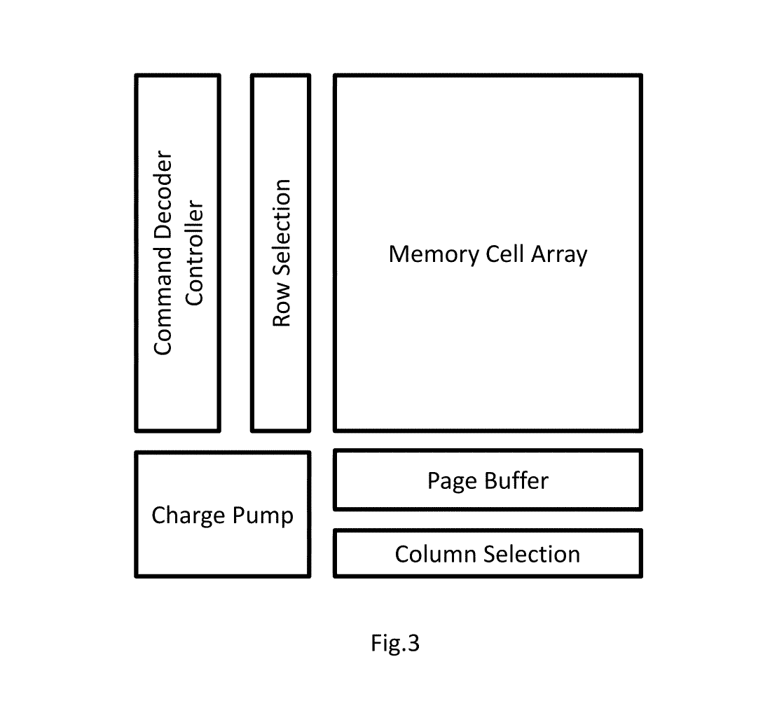

FIG. 3 is a block diagram of a B4 memory die. The B4 memory die includes a row selection circuit for selecting a row of the memory cell array having the circuit shown in FIG. 2, a page buffer for holding data corresponding to one page, namely, one row, a column selection circuit for selecting 16-bit (1-word) data from the data in the page buffer (2-kbit data, i.e., 128-word data), a charge pump circuit for generating and supplying a high voltage, a negative voltage and the like for a write operation, an erase operation or the like, and a command decoder/controller for decoding a command supplied from an external device and controlling various circuits in the B4 memory die.

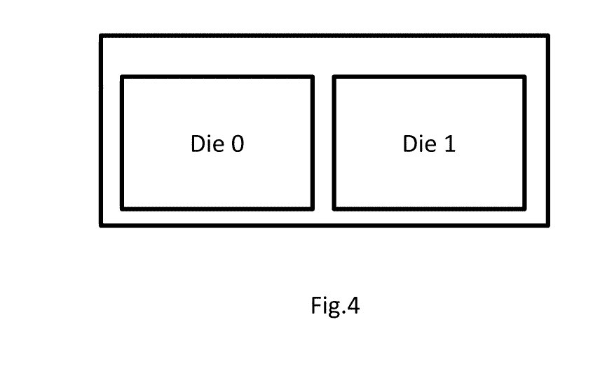

FIG. 4 is a schematic view of a package including a plurality of B4 memory dies. In the example shown in FIG. 4, two dies (Die 0, Die 1) each having a memory capacity of 512 Mbits are enclosed in one package. As a result, the package has a memory capacity of 1 Gbits. The dies respectively include separate chip selection/control signal terminals CE0 and CE1. A multi-level cell (MLC) has a memory capacity which is an integral multiple of the memory capacity of the above-described single-level cell (SLC). In the case where, for example, four threshold value states are stored on one memory cell to hold 2-bit data, the capacity of one die is 1 Gbits. One package including two dies has a memory capacity of 2 Gbits.

USB Memory

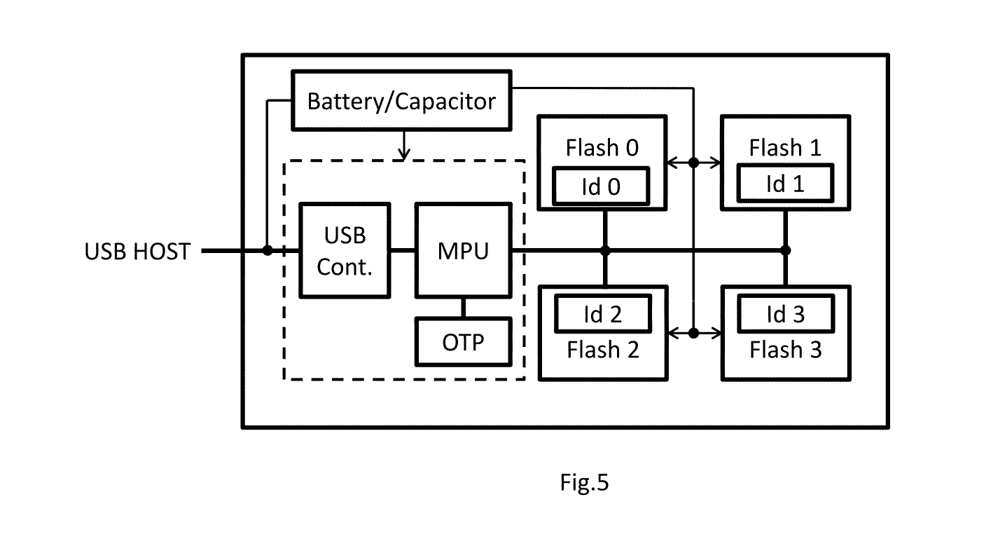

FIG. 5 is a block diagram showing a circuit configuration of a USB memory according to the present invention. The USB memory includes flash memory packages Flash 0 through Flash 3, a controller chip (enclosed by the dashed line in FIG. 5) including a USB controller and an MPU for controlling the flash memories in one chip, and a battery or a capacitor. The controller chip includes an SRAM area for converting a logical address transmitted from a USB HOST into a physical address and caching a part of the FAT area or written data. When receiving, from the USB HOST, a complete data erase command which instructs the USB memory to completely erase data, the USB memory performs the steps of the above-described file erasing method. The circuit is implemented in the form of a USB memory herein, but may be implemented in the form of a memory card, a memory module, an SSD or the like.

One through four packages including the flash memories described above form a storage such as a memory card or a USB memory having a capacity of 1 Gb to 8 Gb. The USB memory is connected to a personal computer and is recognized by a user as a drive similar to an HDD or an SSD under the management of an operating system of the personal computer.

On a storage area of the USB memory, a file managed by the operating system is stored. In general, the size of a document file is several ten kilobits to several ten megabits. Therefore, in many cases, files are recorded over a plurality of pages in one or a plurality of blocks.

Operation When Connected to the Host—USB Having a Battery

When the USB memory shown in FIG. 5 is connected to a USB host (e.g., personal computer), the battery is charged with power supplied from the host via a connector. Similarly, the flash memories Flash 0 through Flash 3 are operated by the power supplied from the host. When a USB interface is used, the power supply voltage provided by the host is 5 V. Therefore, the USB memory includes a DC/DC converter (not shown), which converts the voltage of 5 V into an internal power supply of 1.8 V. The internal power supply of 1.8 V is supplied to the controller chip and the flash memories Flash 0 through Flash 3.

When the USB memory is pulled out from the USB host, the controller chip is switched to be driven by the battery. The USB interface is not supplied with power. The flash memories Flash 0 through Flash 3 are not supplied with power. However, for performing an erase operation performed after a lapse of a set time period, the flash memories Flash 0 through Flash 3 are supplied with power from the battery.

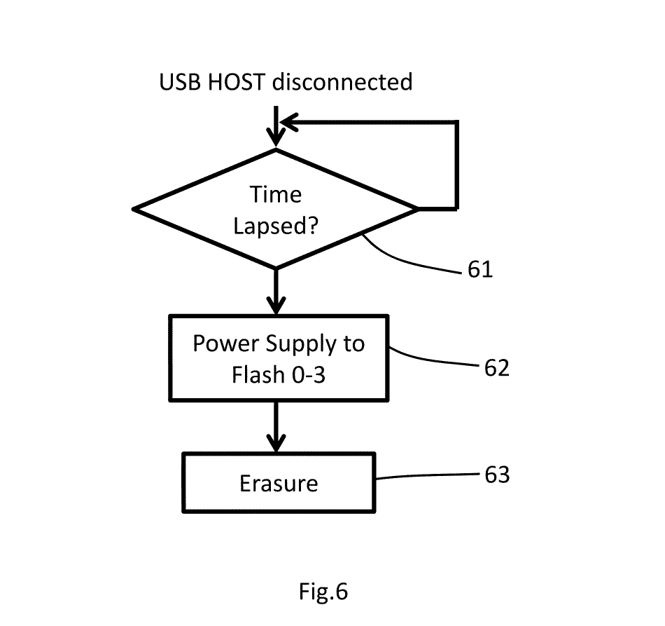

FIG. 6 is a flowchart showing an operation according to the present invention. The MPU in the controller chip is driven by the battery to count a time period from the time when the USB memory is pulled out from the USB host (this operation consumes very little power). After a lapse of a predetermined time period (can be set optionally; the set data is stored in a register in the MPU) (step 61), the MPU turns on a flash memory (step 62) and issues an erase command (step 63). The erase operation performed in conformity to the erase command may erase data in the entire chip, may erase data on a block-by-block basis, or may erase data in a specified file as described later. When a specified block or a specified file is to be erased, information indicating which file is to be erased needs to be stored. Such information may be stored in the register or the SRAM area in the MPU or in a specific area in the flash memory. Instead of the erase operation, a write operation may be performed to put all the bits to a written state.

The battery is used only for measuring the lapse of the set time period and for performing only one cycle of erase operation, and therefore does not need to have a large capacity. A lithium polymer secondary battery having a rating of 3.7 V/300 mAh is sufficient.

Operation When Connected to the Host—USB Having a Capacitor

In a modification of the USB memory described above, the USB memory may use a super capacitor having an F (farad)-order capacitor. A B4 flash memory consumes relatively small power for read, write and erase operations, and therefore requires a capacitance of several to 10 F at the maximum. Such a capacitor is fully charged within several seconds and costs low, and therefore is preferable for the present invention.

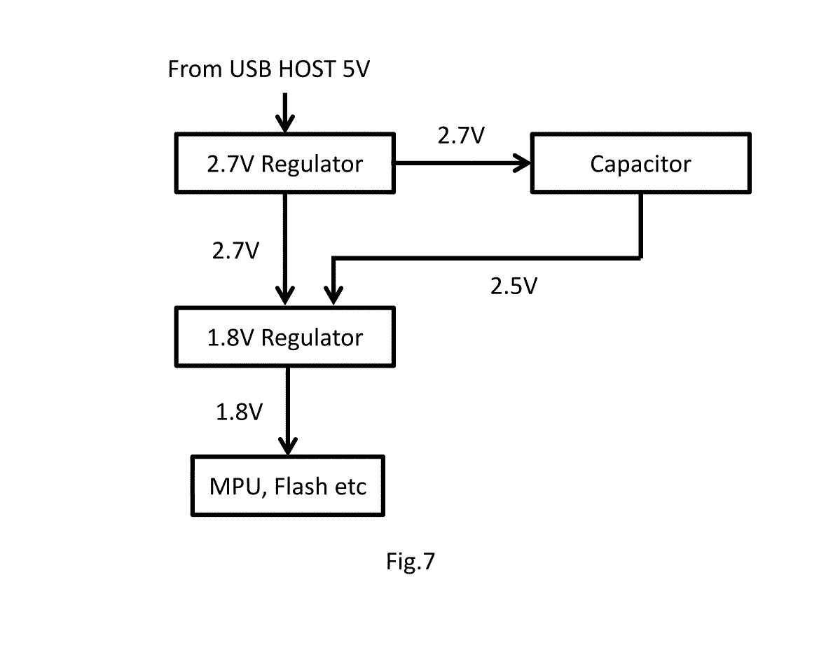

FIG. 7 is a block diagram showing an example in which a super capacitor is charged at 2.7 V and discharged at 2.5 V. A 2.7 V regulator and a 1.8 V regulator are used. The former is used for charging the super capacitor, and the latter outputs 1.8 V from the output of the 2.7 V regulator or the discharge output of the super capacitor (2.5 V). The output of the 1.8 V regulator is supplied to the MPU or the flash memory.

Process When the Battery or the Like is Used Up

As described above, the battery or the super capacitor is used for performing an erase operation or a write operation. When the battery or the super capacitor is not charged for a sufficiently long time, the erase operation or the like may not be performed sufficiently. In such a case, the battery or the capacitor may be always monitored so that when the remaining charge amount is decreased, an erase command is automatically issued even before the lapse of the set time period. Alternatively, when the USB memory is re-connected to the host, the power supplied from the host via the USB interface may be used to issue an erase command so that the erase operation is performed by the flash memory.

Example of Storing a Time Stamp

When the USB memory is pulled out from the host, the time referred to immediately previously (by use of the time of an internet clock acquired via the host) may be stored on a microcomputer. In this case, the next time the USB memory is inserted into the host, the internet time is acquired via the host, and the current time is compared against the time obtained by adding the stored time and the set time period. When the set time period has lapsed, an erase command is issued. Instead of storing the time stamp, the number of times the USB memory has been connected to the host may be stored, so that when the number of times exceeds a prescribed number of times, an erase command is issued. Use of the time of the internet clock can, for example, allow the host side to retroact the time and thus can prevent unauthorized read of data.

Further Security Measure 1

There is a possibility that a user of bad faith attempts to directly read data from a flash memory. In this case, it is usually expected that the battery is pulled out. Thus, in the case where the battery is pulled out, it is desirable to issue an erase command the next time the USB memory is connected to the host.

Further Security Measure 2

A B4 flash memory stores individual identification codes Id0 through Id3. The MPU is connected to an OTP. Authorization codes corresponding to the identification codes (the authorization codes may be the same as, or symmetrical to, the identification codes) are stored in the OTP. For reading data, an identification code and an authorization code are read, and it is checked whether the identification code and the authorization code correspond to each other. Only when it is confirmed that the identification code and the authorization code correspond to each other (e.g., the identification code and the authorization code are confirmed to be identical), data can be read. A circuit for performing control such that the read data is not output unless the identification code is input is provided in the flash memory.

Owing to the above-described security measures, even when a person of bad faith cracks stored information by, for example, reverse-engineering the USB memory, data is not read easily.

Complete Data Erase on a File-by-File Basis

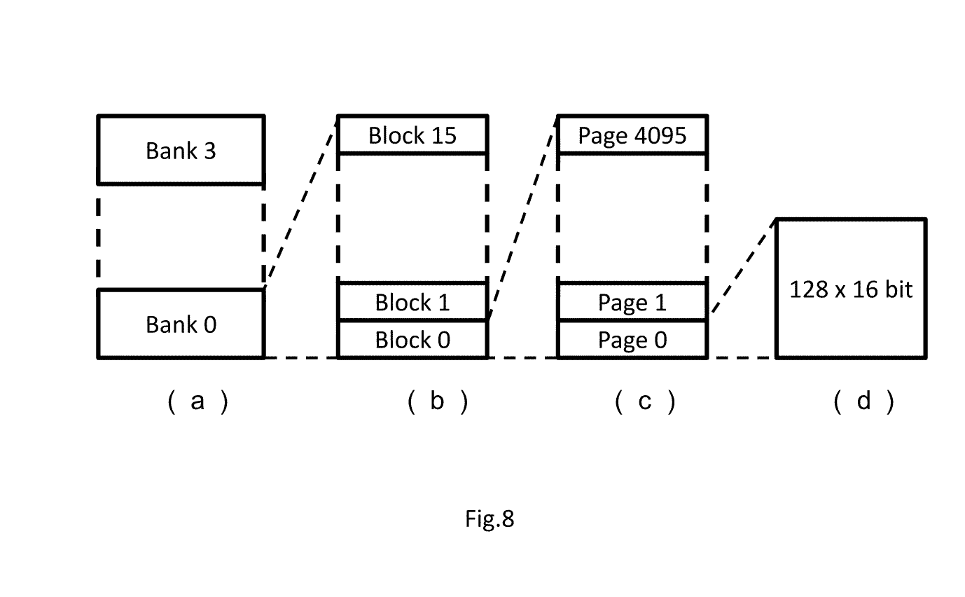

FIG. 8 shows the relationship among banks, blocks and pages in one die. One die includes four banks (Bank 0, Bank 1, Bank 2 and Bank 3). Each bank is divided into 16 blocks (Block 0 through Block 15). Each block is a unit for data erase. Each block is divided into 4096 pages (Page 0 through Page 4095). Each page is a unit for data write. Each page is formed of 2 kbits, namely, 128 words.

According to the file erasing method of the present invention described below, when a file is erased, data in a FAT area is updated and also the substance of the file itself is completely erased physically. Therefore, even if the storage is lost, the data which is once erased is not decrypted. When it is decided not to use a particular storage anymore, the work of overwriting data by use of special software is not necessary. A simple work of erasing data can put the data which is once erased to a non-decryptable state.

File Erasing Method

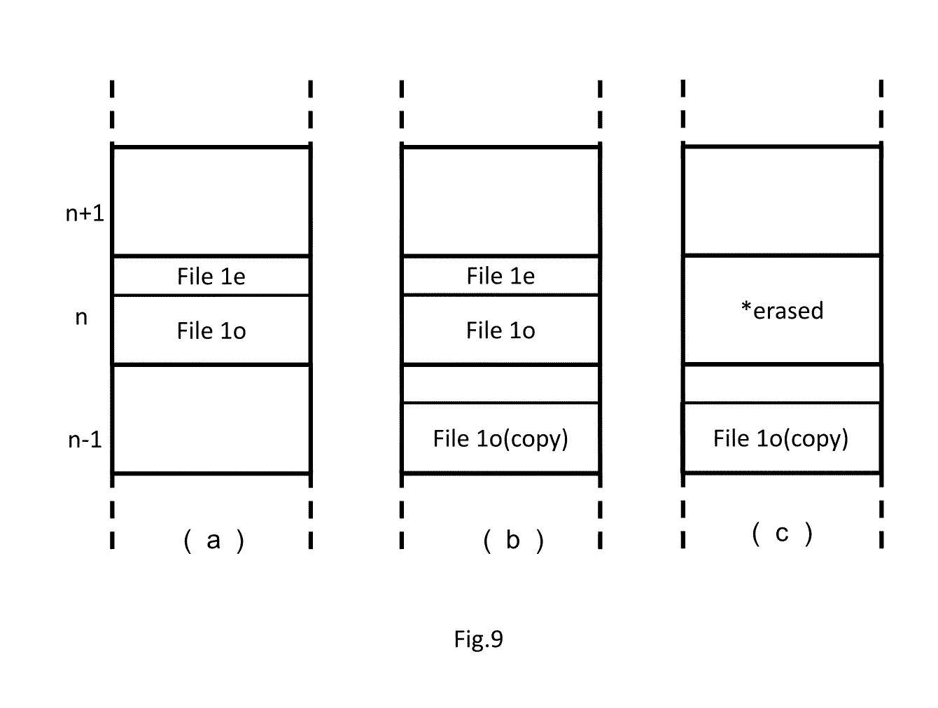

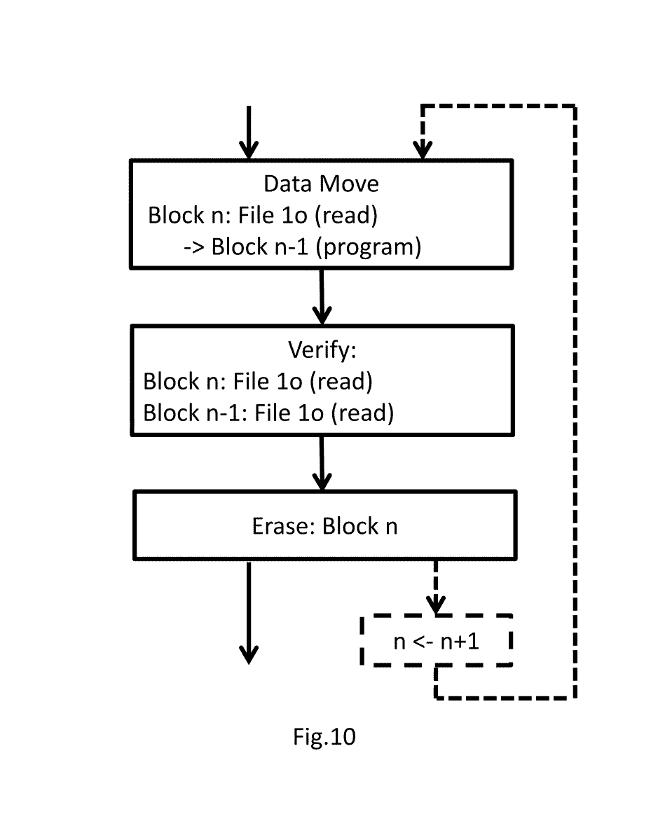

Hereinafter, a file erasing method will be described with reference to FIG. 9 and FIG. 10. As shown in FIG. 9(a), data in File 1e and File 1o is stored in block n. Now, it is assumed that File 1e is to be erased by an instruction from the operating system. File 1e is erased as follows. First, as shown in FIG. 9(b), from the erase block n having the file which is the target of erase stored therein, data other than data in File 1e, which is the target of erase, namely, data in file 1o is read and written to erase block n−1 (when n is 0, the data in file 1o is written to block 15). In this state, the data in File 1o stored in block n and the data in File 1o stored in block n−1 are compared page by page to perform a write verify operation. Then, as shown in FIG. 9(c), all the data in erase block n, in which the file as the target of erase is recorded, is erased. In addition, a pointer to the substance of the file in the FAT area is corrected to a new address (the FAT area is stored on the flash memory, but is in a volatile memory area in the controller when in use). Referring to FIG. 10, the flow represented by the solid line arrow shows the file erasing method according to the present invention.

A currently available 512 M B4 flash memory is estimated to require the following time periods to perform the above-described steps. For reading data of 1 page, about 4.5 s is required. Therefore, for reading data of 1 block, 18 ms is required. In the case where four banks have data written in a dispersed manner, the data needs to be read from the four banks. Therefore, a total of 64 ms is required. For writing data of 1 block, about 624 ms is required. For erasing data of 1 block, 100 ms is required. Therefore, the time necessary for a series of sequences (change of data of about 8 Mbytes) does not exceed 1 second. This rate is sufficiently high for practical use.

This file erasing method may be performed by a NAND flash memory, but is preferably performed by the above-described B4 flash memory because a NAND flash memory is restricted in terms of the number of times of rewrite and also because of the following reasons. In the B4 flash memory, the length of the channel region between the source and the drain can be shortened to raise the integration degree, both of the write operation and the erase operation can be performed at a high rate, the write cycle and the erase cycle are performed by a significantly larger number than in the NAND flash memory, and even after a rewrite operation is performed many times, data can be held stably for a long period of time even at a high temperature. This file erasing method is controlled by a controller for managing an interface of the storage.

The flow represented by the dashed line arrow in FIG. 10 shows an example in which file erase is repeated a plurality of times. Namely, data move (reading data in File 1o in block n and programming the data to block n−1), data verify (comparing the data in File 1o in block n and the data in File 1o in block n−1 for verification), and erase (erasing block n) are repeated by a plurality of cycles.

In the file erase operation, data may be written such that all the memory cells in which the file as a target of erase is recorded are put into the same electronic state (written state). As a result, before a block is erased physically in the flash memory, data read is made impossible. The erase operation is performed at a timing when the erase operation is possible. Namely, from the erase block having the file as the target of erase recorded therein, data other than data in the file as the target of erase is read and written to another erase block. Then, all the data in the erase block, in which the file as the target of erase is recorded, is erased.

Data Terminal 100

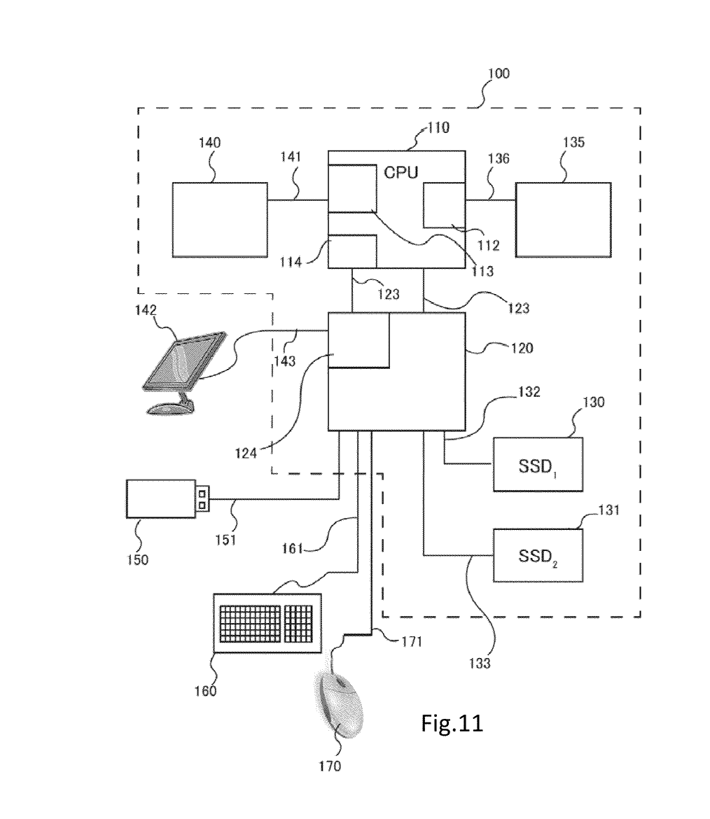

FIG. 11 is a block diagram showing a circuit configuration of the data terminal 100 in an embodiment according to the present invention. The data terminal 100 is provided in the form of a desktop PC, a notebook PC or a tablet PC.

The data terminal 100 is connected to a display 142, a USB memory 150, a keyboard 160 and a mouse 170.

The data terminal 100 includes a CPU 110 for performing computation, a chip set 120 for interfacing with an external device, semiconductor drives 130 and 131 for storing programs (operating system, device driver and application software) and user data, a main memory 135 for temporarily storing any of the programs or user data which is a target of computation performed by the CPU, and a graphic unit 140 for performing image processing.

The CPU 110 includes a memory controller 112 connected to the main memory 135 via a memory bus 136, a graphic bus controller 113 connected to the graphic unit 140 via a graphic bus 141 (e.g., PCI Express 2.0), and a built-in graphic controller 114.

The chip set 120 and the CPU 110 are connected to each other via a CPU bus 123 (e.g., DMI 2.0). The chip set 120 includes a display interface 124 for receiving data from the built-in graphic controller 114 in the CPU 110 or the graphic unit 143 via a flexible display interface bus 123 and outputting the data to the display 142 via a display output bus 143. The chip set 120 is connected to the semiconductor drives 130 and 131 respectively via serial buses 132 and 133 (e.g., SATA 3.0). The USB memory 150, the keyboard 160 and the mouse 170 are connected to the chip set 120 respectively via serial buses 151, 161 and 171 (e.g., USB 3.0).

The semiconductor drive 130 of the data terminal 100 is a usual SSD, whereas the semiconductor drive 131 includes a battery or a super capacitor like the USB memory shown in FIG. 5. Upon receipt of a complete erase command, the semiconductor drive 131 performs the above-described file erasing method in order to erase data on a file-by-file basis.

When the data terminal 100 is turned off, the semiconductor drive 131 performs the same operation as when the USB memory is pulled out from the host. At the time when the data terminal 100 is being turned off, the semiconductor drive 131 may store the time of the internet clock referred to immediately previously. When the data terminal 100 is turned on again, the semiconductor drive 131 may compare the current time against the stored time of the internet clock and perform the process described above in “Example of storing a time stamp”.

The semiconductor drive 130 mainly stores the operating system and a semiconductor drive device driver, whereas the semiconductor drive 131 stores user data. The semiconductor drive device driver includes a program for controlling the CPU 110 and the chip set 120 to transmit a complete erase command to the semiconductor drive 131. The semiconductor drive device driver includes a program for controlling the CPU 110 and the chip set 120 to perform the above-described file erasing method.

As shown in FIG. 6, the USB memory 150 may include a battery or a super capacitor, and may be structured to perform the above-described file erasing method upon receipt of a complete erase command in order to erase data on a file-by-file basis.

The semiconductor drive 130 stores a USB memory driver. The USB memory driver includes a program for controlling the CPU 110 and the chip set 120 to transmit a complete erase command to the USB memory 150. The USB memory driver includes a program for controlling the CPU 110 and the chip set 120 to perform the above-described file erasing method.

Owing to the above-described structure of the data terminal 100, user data which possibly includes sensitive information such as private information or the like or business secrets which need to be kept confidential strictly can be erased with certainty on a file-by-file basis by a complete erase command after a lapse of a prescribed time period. As a result, an inadvertent file leak is prevented as much as possible.

Data Terminal 200

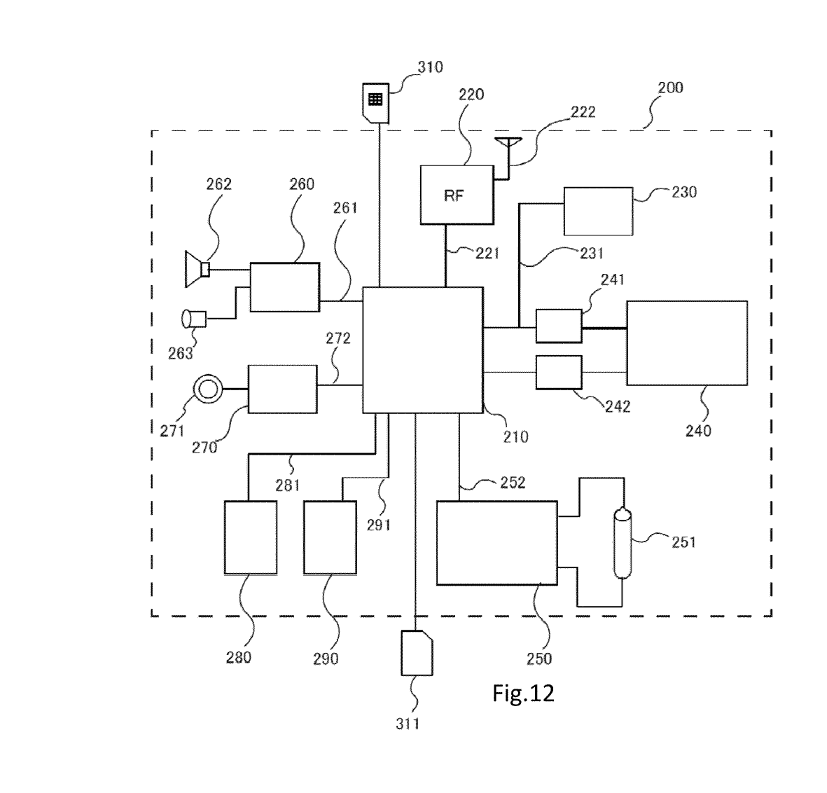

FIG. 12 is a block diagram showing a circuit configuration of a data terminal 200 in an embodiment according to the present invention. The data terminal 200 is provided in the form of a mobile phone, a smart phone or a table mobile terminal.

The data terminal 200 has slots to which a SIM card 310 or a USB memory 311 for storing information can be inserted.

The data terminal 200 includes an application processor 210 for performing computation, a wireless communication unit 220, a sensor 230, a display 240, a power supply management unit 250, an audio unit 260, a camera module 270, a first memory 280 formed of a volatile memory, and a second memory 290 formed of a nonvolatile memory for storing programs (operating system, device driver and application software) and user data.

The wireless communication unit 220 performs communication between the data terminal 200 and an external wireless base station, and is connected to the application processor 210 via a serial bus 221. The wireless communication unit 220 is also connected to an antenna 222.

The sensor 230 includes a temperature sensor, an accelerator sensor, a position sensor, a gyrosensor and the like, and information detected by such sensors is supplied to the application processor 210 via a serial bus 231 (e.g., I2C).

The display 240 is a liquid crystal display or an organic EL display having a touch panel function, and is connected to the application processor 210 via a display interface unit 242 and a touch panel interface unit 241.

The power supply management unit 250 is connected to a lithium ion battery 251, and controls power supply to all the units in the data terminal 200 and charge/discharge of the lithium ion battery 251. The power supply management unit 250 is connected to the application processor 210 via a serial bus 252 (e.g., I2C).

The audio unit 260 is connected to a speaker 262 and a microphone 263, and is connected to the application processor 210 via a serial bus 261 (e.g., I2C).

The camera module 270 is connected to a two-dimensional CMOS sensor 271, and is connected to the application processor 210 via a serial bus 272 (e.g., CSI).

The first memory 280 formed of a volatile memory is connected to the application processor 210 via a memory bus 281. The first memory 280 may be stacked on, and enclosed in the same package with, the application processor 210. The first memory 280 temporarily stores any of the programs (operating system and application software) or user data which is a target of computation.

The second memory 290 formed of a nonvolatile memory is connected to the application processor 210 via a memory bus 291 (e.g., USB 3.0). The second memory 290 may be stacked on, and enclosed in the same package with, the application processor 210. The second memory 290 stores the programs (operating system and application software) and user data.

The second memory 290 of the data terminal 200 is structured to perform the above-described file erasing method upon receipt of a complete data erase command, like the USB memory shown in FIG. 6. The second memory 290 has substantially the same circuit configuration as that shown in FIG. 6 except for the interface.

As described above, the second memory 290 stores the operating system and a semiconductor drive device driver (may be one element of the operating system). The semiconductor drive device driver includes a program for controlling the application processor 210 to transmit a complete erase command to the second memory 290. The semiconductor drive device driver includes a program for controlling the application processor 210 to perform the above-described file erasing method.

As shown in FIG. 6, the USB memory 311 may include a battery or a super capacitor, and may be structured to perform the above-described file erasing method upon receipt of a complete erase command in order to erase data on a file-by-file basis.

The second memory 290 stores a USB memory driver. The USB memory driver includes a program for controlling the application processor 210 to transmit a complete erase command to the USB memory 311. The USB memory driver includes a program for controlling the application processor 210 to perform the above-described file erasing method.

Owing to the above-described structure of the data terminal 200, user data which possibly includes sensitive information such as, for example, a telephone or address list or business secrets which need to be kept confidential strictly can be erased with certainty on a file-by-file basis by a complete erase command after a lapse of a prescribed time period. As a result, an inadvertent file leak is prevented as much as possible.

A mobile terminal such as the data terminal 200 may be lent to a plurality of users. The complete erase command according to the present invention mounted on the mobile terminal allows the mobile terminal to be lent to one user and then to another user.

As described above, according to the storage medium using the nonvolatile semiconductor storage device and the data terminal of the present invention, user data which possibly includes sensitive information such as private information or the like or business secrets which need to be kept confidential strictly can be erased with certainty on a file-by-file basis by a complete erase command after a lapse of a prescribed time period. As a result, an inadvertent file leak is prevented as much as possible.

What is claimed is:

1. A storage medium comprising:
a nonvolatile semiconductor storage device; and
a control unit, after a lapse of a set time period, (a) for writing data to memory cells storing data corresponding to files stored on the storage medium, such that all the memory cells are rendered into the same electronic state, or (b) for erasing data from the memory cells.

2. The storage medium according to claim 1, wherein the control unit includes a clock counting a lapse of the set time period.

3. The storage medium according to claim 2, further comprising a battery, wherein when the storage medium is connected to another device, the battery is charged by the another device, and wherein when the storage medium is disconnected from the another device, the battery supplies power to the nonvolatile semiconductor storage device and the control unit.

4. The storage medium according to claim 2, further comprising a capacitor, wherein when the storage medium is connected to another device, the capacitor is charged by the another device, and wherein when the storage medium is disconnected from the another device, the capacitor supplies power to the nonvolatile semiconductor storage device and the control unit.

5. The storage medium according to claim 1, wherein the nonvolatile semiconductor storage device holds a lapse period information related to the set time period; and wherein when the storage medium is connected to another device, the control unit reads the lapse period information and acquires time from the another device; and when the control unit determines that the set time has lapsed, the control unit (a) writes data to the memory cells which store data corresponding to the files stored on the storage medium, such that all the memory cells are rendered into the same electronic state, or (b) erases data from the memory cells.

6. The storage medium according to claim 5, wherein the set time period is created based on time acquired by the another device via the Internet, and the time acquired by the control unit from the another device is also acquired via the Internet.

7. The storage medium according to claim 5, wherein the control unit reads the stored file only after writing or erasing the data.

8. The storage medium according to claim 1, wherein:
the nonvolatile semiconductor device holds a unique identification code;
the control unit holds an authorization code corresponding to the identification code; and
only when the identification code and the authorization code correspond to each other is the control unit allowed to access the nonvolatile semiconductor device.

9. The storage medium according to claim 1, wherein the storage medium is included in a data terminal.

10. The storage medium according to claim 9, wherein the storage medium stores user data.

11. The storage medium according to claim 2, wherein the storage medium is included in a data terminal.
